(19) United States
(12) Patent Application Publication
(10) Pub. No.: US 2019/0152158 A1
(43) Pub. Date: May 23, 2019

(54) PROJECTION-ASSISTED EXCAVATION OF POWDER BASED 3D PRINTING

(71) Applicant: Youngstown State University, Youngstown, OH (US)

(72) Inventors: Eric MacDonald, Columbiana, OH (US); Darrell Wallace, Youngstown, OH (US); Mark Lamoncha, Leetonia, OH (US); Brett Conner, Poland, OH (US); Scott Conner, Poland, OH (US)

(73) Assignee: Youngstown State University

(21) Appl. No.: 16/196,926

(22) Filed: Nov. 20, 2018

Related U.S. Application Data
(60) Provisional application No. 62/589,265, filed on Nov. 21, 2017.
(60) Provisional application No. 62/645,338, filed on Mar. 20, 2018.

(51) Int. Cl. B29C 64/393; B22F 3/00; B29C 64/35; B29C 64/153

(52) U.S. Cl. CPC B29C 64/393; B29C 64/153; B29C 64/35; B22F 3/004

(57) ABSTRACT

A projector or system for assisting in a removal of 3D printed molds from a print chamber. The projector is operative to receive a file in a format compatible for a 3D printer. The projector further receives input corresponding to a location of the prototype contained in a powder box and input corresponding to a profile of powder contained across a surface of the associated powder box. Using the location, a portion of the prototype located immediately beneath a surface of powder in the powder box is determined. A distance of the portion to a selected region of the top surface is also determined. A cue is generated based on the distance. The projector generates an image of the extracted layer and projects the image onto the surface of the associated powder box. The image comprises at least one color coded region within a proximity of the portion, where a color of the color coded region is based on the cue.

This application claims priority from U.S. Provisional Patent Application No. 62/589,265, filed Nov. 21, 2017 and U.S. Provisional Patent Application No. 62/645,338, filed Mar. 20, 2018, the entire disclosures of which are hereby incorporated by reference herein.

### BACKGROUND

The present disclosure is directed to a projection assist system and method for removing a prototype from the powder bed of a 3D printer. It finds particular application in additive or layered manufacturing, and will be described with particular reference thereto. However, it is to be appreciated that the present exemplary embodiment is also amenable to other like applications.

Powder bed fusion and binder jetting are two of the seven ASTM recognized forms of three-dimensional (3D) printing that uses a laser, electron beam or another heat source to selectively fuse successive layers of powder to form a prototype. In the case of binder jetting, inkjet nozzles deposit binder across the powder to form a final product. In the case of powder fed fusion, a laser moves across the powder to sinter the powder material into the final product. Both processes rely on a powder bed to form 3D structures in which new powder (metal powder, sand or an alternate powder build material) is added to the print box as a platform is lowered. The selective fusion or binding is continued one layer at a time, until a three-dimensional prototype is printed from the bottom up.

The completed prototype is not visible underneath the powder. To remove the prototype, the operator(s) can vacuum the loose powder and potentially reuse the recaptured powder on the next run. FIG. 1 is a perspective top view of operators 10 manually performing the excavation of prototypes 12 from a powder box 14 using a vacuum 16 according to the PRIOR ART. The operator can also use a brush 18 to move the remaining powder 20 away from the prototype. These operations are performed blind due to the obscuring of the object by the powder, although there is available a system that can display a 3D virtual representation of the completed prototype on a nearby computer screen to guide the operator. These systems display a visual rendering of the powder chamber as a cube to allow the operator to estimate where the prototype is generally located.

However, the prototypes are very fragile, and can include very intricate features. After removal from the printer, some prototypes require further processing—using, for example, UV light, a furnace, or a salt bath—to set the material. Because the operator cannot see the prototype under the powder, many prototypes are damaged when the operator breaks or vacuums an outlying part during the excavation. This damage is problematic for multiple reasons. Mainly, the time and material involved in reprinting the prototype is costly to the manufacturer.

Therefore, an improved approach is desired for safely excavating a printed prototype without damaging it. A system and method is desired which would provide an operator with a visual rendering of the critical features of the printed prototype beneath the surface of the powder. A system and method is further desired which would provide an operator with a visual rendering of the immediate features of the prototype that are being excavated.

### BRIEF DESCRIPTION

One embodiment of the present disclosure is directed to a projector or system for assisting in a removal of 3D printed molds from a print chamber. The projector includes a memory storing instructions and a processor programmed to execute the instructions. The processor is operative to receive a file in a format compatible for a 3D printer. The file includes instructions for printing a model of an associated prototype as a series of layers. The processor is further operative to receive input corresponding to a location of the associated prototype contained in an associated powder box. Using the location, the processor is operative to determine a portion of the associated prototype located immediately beneath a top surface of powder in the associated powder box. The processor is operative to determine a layer of the model corresponding to the portion. The processor is operative to extract the layer from the file and generate an image of the extracted layer. The image is projected onto the top surface of the associated powder box.

One embodiment of the present disclosure is directed a projector or system for assisting in a removal of 3D printed molds from a print chamber. The projector comprises a memory storing instructions and a processor programmed to execute the instructions. The processor is operative to receive a file in a format compatible for a 3D printer. The file includes instructions for printing a model of a prototype as a series of layers. The processor is further operative to receive input corresponding to a location of the prototype contained in a powder box. The processor is further operative to receive input corresponding to a profile of powder contained across a surface of the associated powder box. Using the location, the processor is operative to determine a portion of the prototype located immediately beneath a surface of powder in the powder box. The processor also determines a distance of the portion to a selected region of the surface. The processor generates a cue based on the distance. The processor is operative to determine a layer of the model corresponding to the portion and extract the layer from the file. The processor is operative to generate an image of the extracted layer and project the image onto the surface of the associated powder box. The image comprises at least one color coded region within a proximity of the portion, where a color of the color coded region is based on the cue.

### BRIEF DESCRIPTION OF THE DRAWINGS

FIG. 1 is a perspective top view of an excavation of sand molds according to the PRIOR ART.

FIG. 2A is a perspective view of the system according to the present disclosure.

FIG. 2B is a perspective view of the system according to another embodiment of the present disclosure.

FIG. 2C is a perspective view of the system according to another embodiment of the present disclosure

FIG. 3 is a schematic illustration of a system according to the present disclosure.

FIG. 4A is a sample projection generated according to one embodiment using the system of FIG. 3.

FIG. 4B is a sample projection generated according to another embodiment using the system of FIG. 3.

FIG. 4C is a sample projection generated according to another embodiment using the system of FIG. 3.

FIG. 4D is a sample projection generated according to another embodiment using the system of FIG. 3.

FIG. 5 is a flow chart illustrating a projection-assisted method for removing molds using the system of FIG. 3.

FIG. 6 is a flow chart illustrating a method for providing a cue with the projection.

FIG. 7 is a cross-sectional view of the system according to one embodiment of the disclosure.

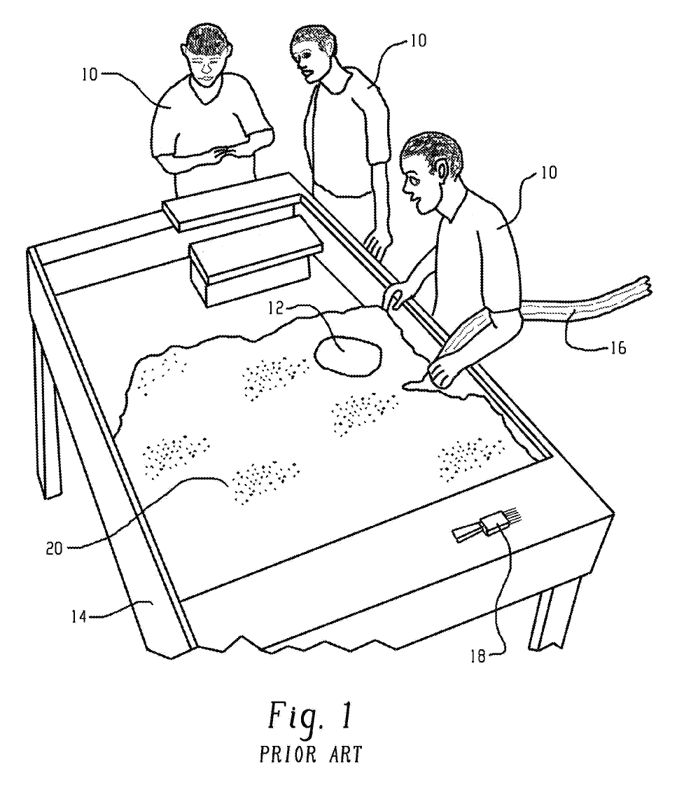

### DETAILED DESCRIPTION

The present disclosure is directed to a system and method that facilitates a safe excavation of a printed prototype or sand mold by providing a projection of a portion of the prototype onto the powder bed. Images of the intended layer geometries for a specific layer of a completed prototype are projected upon the current top layer of the powder to identify the location of parts submerged directly below the surface. The projected images guide an operator in the manual excavation of the printed mold.

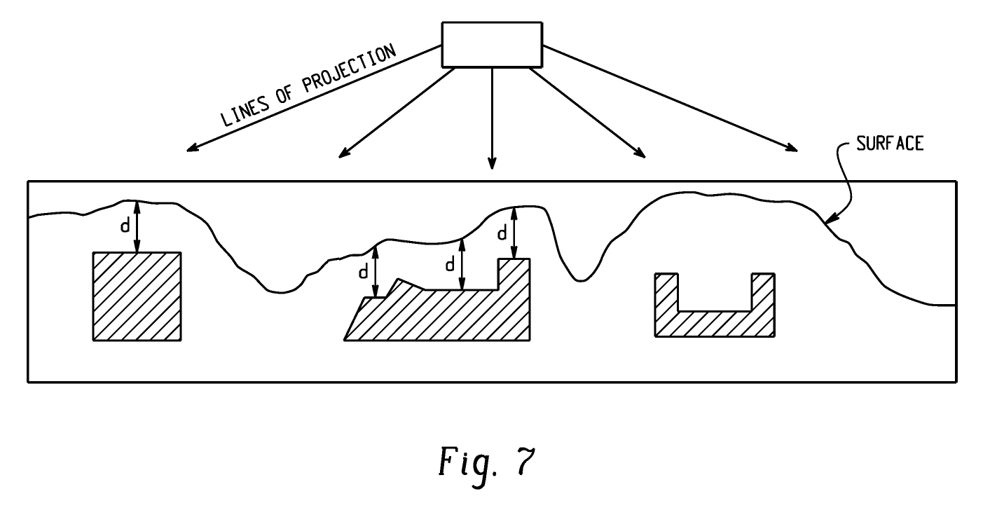

During the excavation process, the un-bonded powder that surrounds the prototypes will be removed incrementally by scooping, vacuuming, or some other means. This process creates a topological surface that changes as material is removed. The proximity of that excavated surface relative to the prototype parts is one parameter of concern. That distance is illustrated by the dimensions labeled ‘d’ in FIG. 7.

To facilitate the safe excavation of a printed prototype, the present disclosure is directed to a projection system that provides visual or audible cues corresponding to the approaching geometry of the buried prototype. An embodiment is contemplated that guides a user with cues, which indicate the level of caution that the system advises for the user to exercise when moving the sand away from the prototype in a select region.

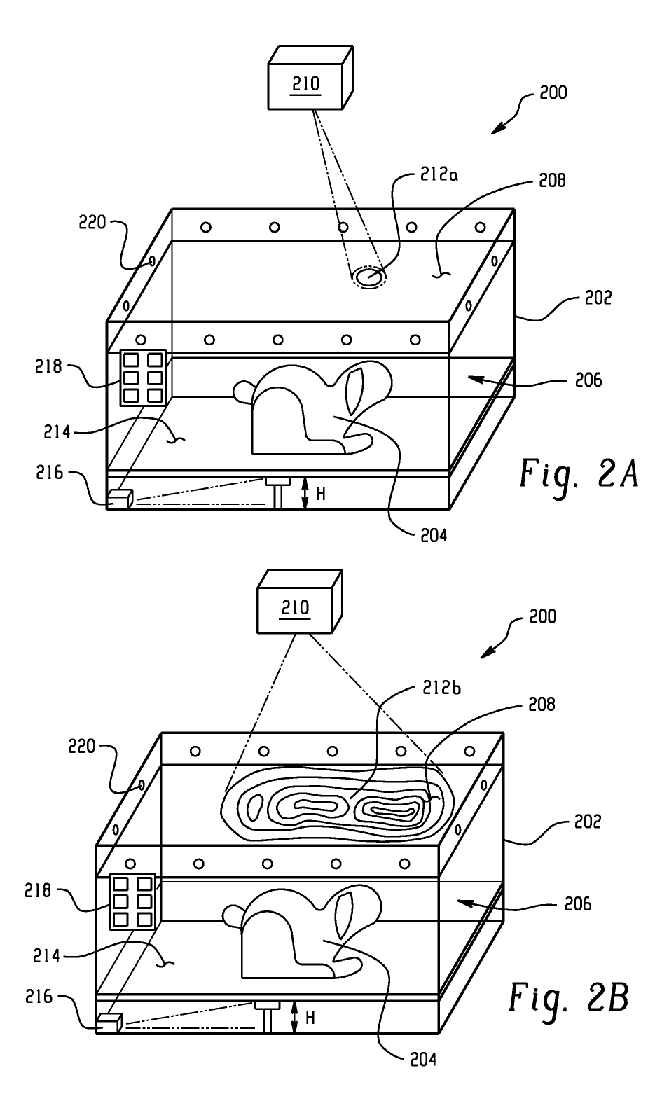

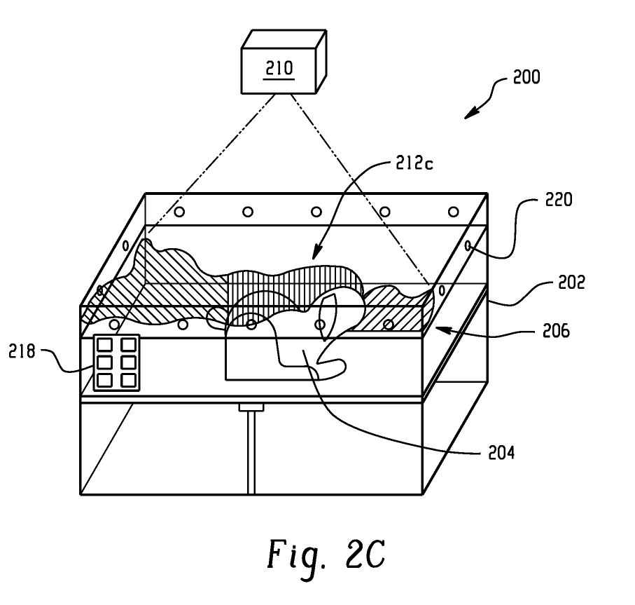

FIGS. 2A-2C are perspective views of the system 200 according to the present disclosure. The system includes a binder jetting powder box 202, which is operative to work in conjunction with a 3D printer. In FIGS. 2A-2C, the powder box 202 is removed from the 3D printer after the printing of the binder jetted parts (sand molds, prototypes) is complete. In the contemplated method, the powder box 202 is received with at least one prototype 204 fully submerged in the powder 206. The prototype(s) is buried and obscured below a surface 208 of the powder.

A projector 210 is located above the surface 208 of the powder 206. In one embodiment, the projector 210 is mounted or suspended above the powder box 202 using any connection arrangement known in the art. The projector 210 is operative to project a two-dimensional (2D) image 212 upon the surface 208 of the powder box 202. The projector 210 projects the image 212a horizontally and generally parallel to the surface 208 of the powder box 202. The selected image (FIG. 2A) corresponds to the specific layer of the prototype that is located immediately under the surface 208, but buried in powder 206.

In another embodiment shown in FIG. 2B, the projection 212b can include a surface map. The projector can map a 2D representation of the entire surface of the prototype, whereby different sections of the surface can be projected with different layers depending on the sections' depth in the powder.

In another contemplated embodiment shown in FIG. 2C, the projection 212c can include color or audible (not shown) indicators that each indicate the amount of caution that should be used while removing powder from within the region. The color is indicative of the fragility of the buried prototype piece or part, which is approaching the surface. The color changes over time based on how close the prototype is to the surface and based on how fragile the part is. In this embodiment, the disclosure contemplates that the surface is not always level when powder is moved away from one region before another. Furthermore, the disclosure contemplates that a profile of the surface is continuously changing when the powder is being moved away from the prototype. Therefore, one aspect of the system is that it updates the projected image and cues in real-time according to the changing profile of the surface.

An operator, through a manual operation, or using a robotic or automated arm, can use the projection to identify the location of the parts of the sand mold that are submerged in the powder 206 and just beneath the surface 208. The projected image 212 allows the operator to know what part of the prototype, and intricate details thereof, is located just beneath the surface 208 as he or she vacuums and/or brushes away loose powder. In this manner, the operator can avoid accidentally bumping, scratching, or damaging the prototype 204.

In one embodiment, a moving bed or platform 214, supporting a build plate, selectively moves upward during the excavation process to allow for the printed prototype to be extracted from the top down. The platform 214 allows for the powder to be moved away from the mold, one layer at a time, until only the prototype is left on the build plate. Depending on the particular method, post-processing operations might include separation from the build plate, among other operations.

In one embodiment, controls 218 located on or proximate to the powder box 202 allow for the platform 214 to be selectively raised and/or lowered as the powder is removed away from the prototype, thus exposing portions of the prototype. Alternatively, the graphic user interface (controls) can be incorporated in a remote controller that is connected to the powder box controller.

In one embodiment, at least one sensor 216 is in communication with the platform 214 and is operative to measure a height of the platform. In one embodiment, the sensor is operative to relay the height measurement to the projector, which uses the height measurement to determine which image or map to project onto the surface 208 of the powder box 202. There is no limitation herein to the type of measurement that is being taken by the sensor. A sensor 216 can be used to relay a measurement as input to the processor, which uses the input to determine which image to project onto the surface 208.

In one embodiment, at least one sensor 220 is in communication with a processor (not shown) and is operative to detect powder in proximity to the prototype 204. For example, a powder depths sensor, such as a set of laser sensors 220, is operative to detect an object (powder) in front of the sensors and use the various detections to generate a surface depth map onto the surface 208 of the powder box 202. The powder depth detections can also be used as input, in combination with the known location of the prototype, to generate at least one visual or audible indicator corresponding to designated regions of the surface. Each indicator corresponds to the amount of caution to be exercised by the user when moving powder in a select region.

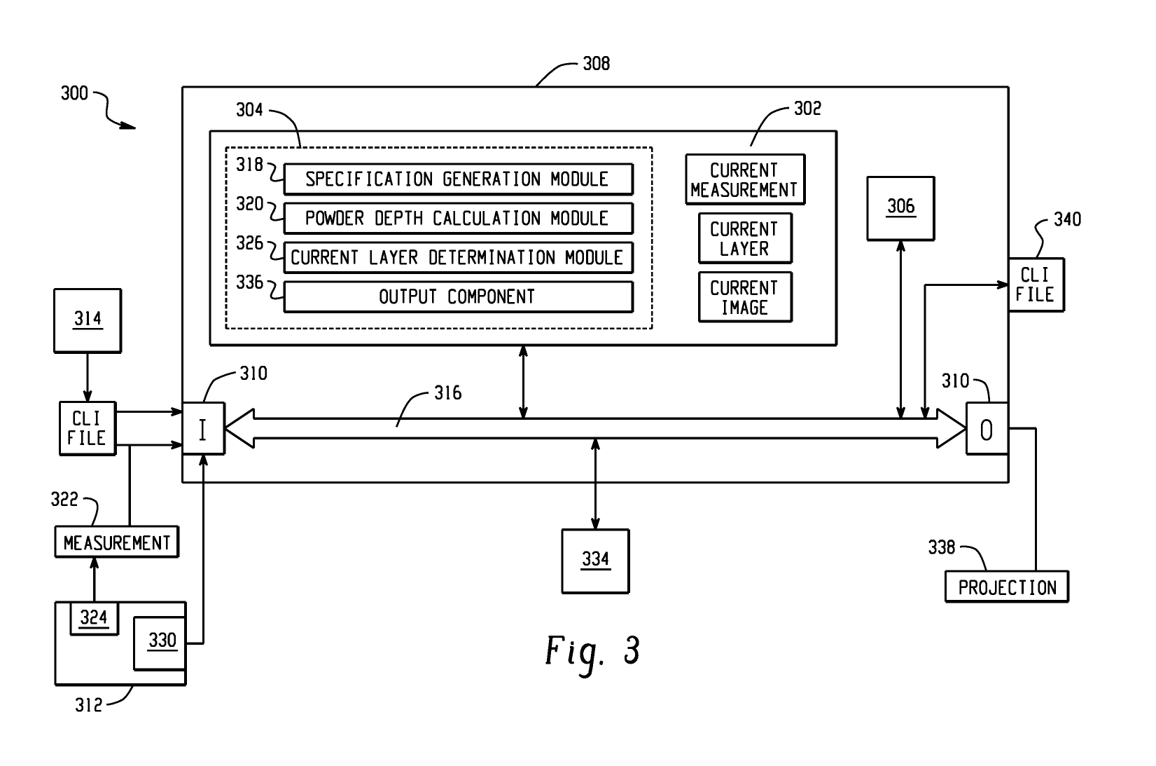

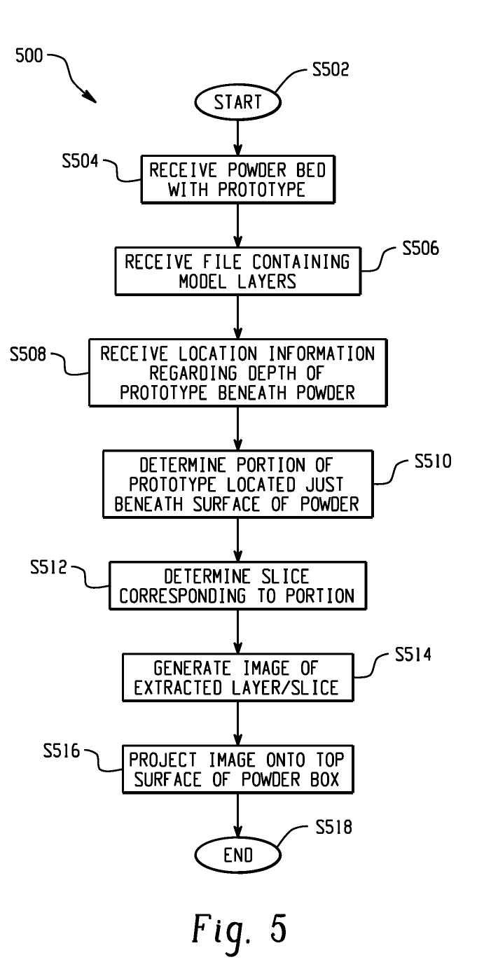

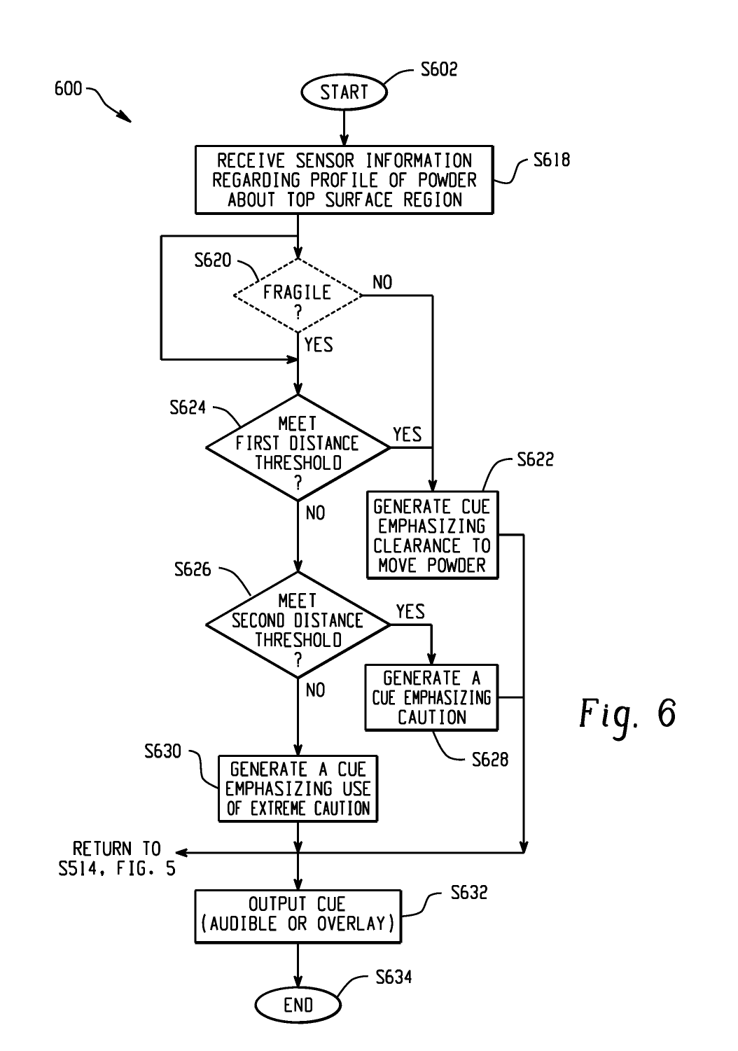

FIG. 3 is a schematic showing a computer-implemented system 300 for removing printed parts from a powder bed of a 3D printer, according to the present disclosure. The system 300 includes a memory 302, which stores instructions 304 for performing the method illustrated in FIG. 5 and a processor 306 in communication with the memory for executing the instructions. The system 300 may include one or more computing devices 308, such as the illustrated projector 308 or a server computer. One or more input/output devices 310 allow the projector 308 to communicate with external devices, such as a powder box 312, remote computer 314, and/or other sources of input, via wired or wireless links, such as a LAN or WAN, such as the Internet. The hardware components 302, 306, 310 of the system communicate via a data/control bus 316.

The illustrated instructions include a specification generation module 318, a powder depth calculation module 320, a current layer determination module 326, and output component 336.

The specification generation module 318 receives a native common layer interface (CLI) file or an alternative language file that describes the geometries on every layer. There is no limitation made to the file format received, as long as the file is compatible with a 3D printer. Generally, such files include instructions for printing a model of the prototype as a series of layers. More specifically, a 3D print job starts with a virtual blueprint of an object to be printed. A software program divides the object into digital cross-sections so that the 3D printer is able to build it layer by layer. The CAD is converted to a language or format that the 3D printer understands, such as standard file extension (.STL file) or the .CLI file. Module 318 reads the file. Module 318 may selectively store the 2D images (or layers) of the file in a database 340, which is in communication with the system 300.

The powder depth calculation module 320 receives input regarding the current depth of the powder in various regions of the powder box. In one embodiment, module 320 receives a measurement 322 from at least one powder depth sensor 324 in communication with the projector 308. There is no limitation made herein on the type of measurement being received at the projector 308. In one embodiment, the measurement 322 can include a position or height of the platform in the powder bed 310. In another contemplated embodiment, the sensor may sense the object, such as the prototype, just beneath the sand. In another embodiment, the sensor may sense the powder, and use the detections to determine the depth of the powder in various regions of the powder box. Module 320 determines the location and/or depth of the prototype in the powder bed using the measurement(s).

The current layer determination module 326 determines the portion of the prototype that is located just beneath the surface of the powder box, and which is covered in powder. In one embodiment, module 326 can determine the portion using the known location of the platform and the layer of the prototype that was built by the printer when the platform was at the same location during the printing process. This information can be extracted from the CLI file.

Using the current layer information, module 326 determines the cross-section, slice or layer that corresponds to the location of the prototype just beneath the surface of the powder box. The module 326 can extract the image (from the CLI file) that was used by the 3D printer to build the layer during the printing process. Module 326 can obtain the image(s) from a database 340 in communication with the projector 308.

However, the present disclosure also contemplates that the current layer to be projected at a given time can also or alternatively be selected manually with a wireless remote or controlled by the powder bed control 330. In such embodiments, a display module can display 2D images of the layers on a display in direct or remote connection with the projector 308. The images are extracted from the CLI file. A graphic user interface (GUI) 334 allows the operator to scroll through the images and select a specific image for projecting onto the surface of the powder bed. The GUI 334 can include a display for displaying the information, to operators, and a user input device, such as a keyboard or touch or writable screen, for receiving instructions as input, and/or a cursor control device, such as a mouse, touchpad, trackball, or the like, for communicating operator input information and command selections to the processor 306.

Using the powder depth information relative to the platform or relative to the computed location of the prototype, the output component 336 outputs a projection 338, which is a 2D image of a cross-section of the prototype that is immediately below the surface of powder in the powder box. Specifically, the output component 336 projects the image 338 as a visual rendering of the current layer onto the surface of the powder box. The projected image changes in real-time with each movement of the platform.

In another embodiment, the output component 336 generates a visual or audible cue to further notify the user of the proximity of the approaching part of the prototype just beneath the surface. The color or sound functions as a code to indicate how close the prototype is to the surface. In another embodiment, the cue corresponds with how fragile and/or delicate the part(s) of the prototype are just beneath the surface of the powder, and it provides the user with guidance regarding the amount of caution that the user should use. For example, using the known layers on the CLI file and the detected powder depths, the output component can generate a color coded projection that displays different colors depending on the fragility of the parts that are beneath the surface and/or how close the parts are to being contacted by the user. In an illustrative example, the projector can display the color green onto the surface of the powder box where the prototype is not beneath the surface. The color green indicates that the user can freely go about removing the sand—manually or with equipment—without risking any unintended contact with the prototype. The color yellow can indicate that the user can freely go about removing the sand, but a portion of the prototype is approaching the surface and can be in proximity to the surface. The yellow indicates caution, and that the user should take some care while removing sand from the region. The color red can indicate that the user should exercise extreme caution while removing the sand from the region because the prototype is immediately beneath the powder and is at risk of being damaged should the user contact it.

In a different contemplated embodiment, the color code can be implemented to further indicate the fragility of the prototype. For a prototype that has no delicate pieces or parts, the projector can project the color green onto the surface of the powder, even if the prototype is immediately beneath the surface of the powder and can be contacted by the user removing sand therein that region. The green color can guide the user by indicating that the prototype is sturdy and is not at risk of being damaged should a vacuum or brush come into unintended contact with the prototype. The red color can indicate that the part of the prototype within the red region is very fragile and delicate, and the red color can guide the user by indicating that the prototype is at risk of being damaged should the vacuum or brush contact it. A yellow color can indicate that the part of the prototype within the yellow region contains projections or pieces that may be damaged should the vacuum or brush contact it.

In one embodiment, the color can be projected onto the surface over the visible powder regions. In a different embodiment, the color can be projected onto the surface over the underlying prototype.

In one embodiment, the cues can be audible instead of, or in addition to, the color indicators. The projector can comprise a speaker that delivers a sound that is known to correspond with the proximity of a part. For example, when a green region changes to a yellow region, a beeping sound can alert the user of the distance that the prototype is relative to the surface of the powder. The beeping sound can include spaced apart beeps that grow closer together as more powder is moved away from the prototype. The spacing of the beeps corresponds to the distance between the prototype and the surface. In other words, the audible warning changes with the depth of the prototype relative to the surface.

The projected color cue or audible cue changes in real-time with each detected movement of the powder. Therefore, as powder is removed from the chamber, or shifted from one part of the chamber to another, the cue changes if the processor computes that a change in the level of caution is recommended. The various levels are predetermined. For example, the fragility of the parts can be predetermined and put into the CLI file. The proximity to the parts can also be predetermined, and when the distance between the surface and the part reaches the predetermined threshold, the cue can change.

The computer system 300 may include one or more computing devices, such as a PC, such as a desktop, a laptop, palmtop computer, portable digital assistant (PDA), server computer, cellular telephone, tablet computer, pager, combinations thereof, or other computing device capable of executing the instructions for performing the exemplary method.

The memory 302 may represent any type of non-transitory computer readable medium such as random access memory (RAM), read only memory (ROM), magnetic disk or tape, optical disk, flash memory, or holographic memory. In one embodiment, the memory 302 comprises a combination of a random access memory and read only memory. In some embodiments, the processor 306 and memory 302 may be combined in a single chip. Memory 302 stores instructions for performing the exemplary method as well as the processed data

The network interface 310 allows the projector 308 to communicate with other devices via a computer network, such as a local area network (LAN) or wide area network (WAN), or the internet, and may comprise a modulator/demodulator (MODEM), a router, a cable, and/or Ethernet port.

The digital processor device 306 can be variously embodied, such as by a single-core processor, a dual-core processor (or more generally by a multiple-core processor), a digital processor and cooperating math coprocessor, a digital controller, or the like. The digital processor 306, in addition to executing instructions 304 may also control the operation of the computer 308.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

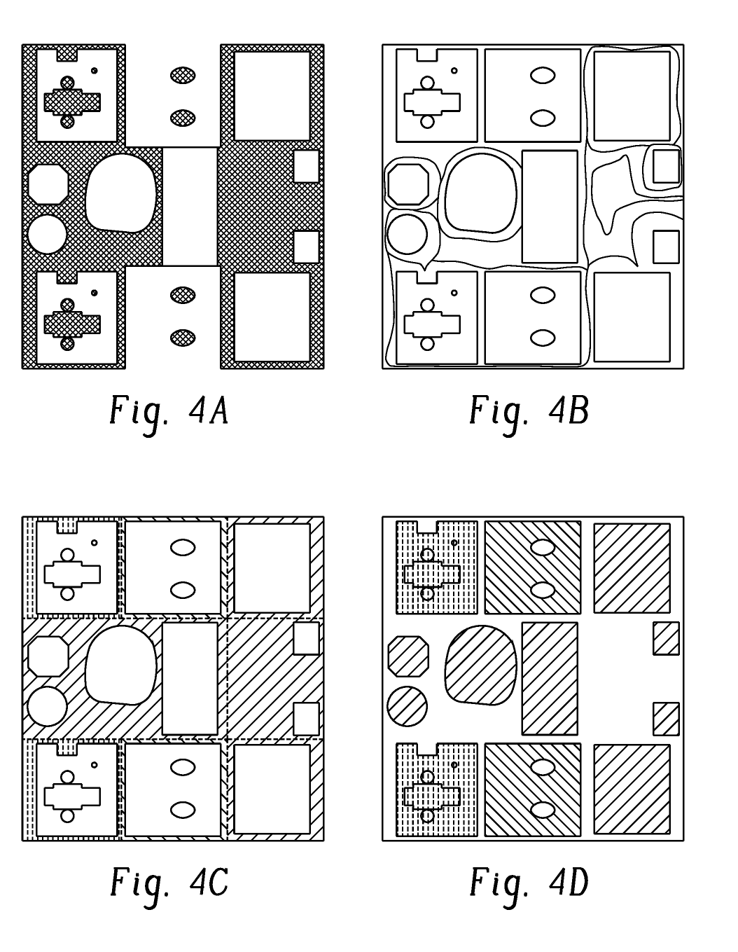

FIG. 4A is a sample projection generated using the system of FIG. 3. Specifically, FIG. 4A shows an image—a single slice of the job box—generated from the projection system. The image is obtained from the CLI file and is displayed onto the powder to help the operator gauge the location of the next feature to emerge from the powder being vacuumed from the box.

FIG. 4B is another embodiment of the sample projection of FIG. 4A, further including a surface map. The surface map is shown as a 2D contour map that indicates the depth of the prototype beneath the surface.

FIG. 4C is another embodiment of the sample projection of FIG. 4A, further providing color indicators (shown in FIG. 4C as different patterns respectfully representing the colors of R (red), Y (yellow) and G (green) for illustrative purposes only) corresponding to the depth and/or the fragility of the prototype beneath the surface. FIG. 4C shows the color being displayed onto the powder regions surrounding the prototype. FIG. 4C illustrates sample virtual regions, although there is no limitation made herein to the profile of the regions.

FIG. 4D is a perspective view of another embodiment of the sample projection of FIG. 4C, also providing color indicators (shown as patterns respectfully representing the colors of R (red), Y (yellow) and G (green) in the figure for illustrative purposes only) corresponding to the depth and/or fragility of the prototype beneath the surface. FIG. 4D shows the color being displayed onto the powder region above the prototype. As discussed supra, an audible cue can also or alternatively provide the cue. There is no limitation made herein to the type of cue, such as colors and sounds, etc. The crux of the cue is to provide different warnings based on predetermined levels each corresponding to the proximity of the prototype to the surface and/or the fragility of the prototype.

FIG. 5 is a flow chart illustrating a projection-assisted method 500 for removing molds using the system of FIG. 3. The method 500 starts at S502. At S504, the system receives a powder bed with a printed prototype. At S506, the system receives a file in a format compatible for a 3D printer. The file includes instructions for printing a model of a prototype as a series of layers. At S508, the system receives input corresponding to a location of the prototype contained in the powder box. Using the location, a portion of the prototype located immediately beneath a surface of powder in the powder box is determined at S510. A layer of the model corresponding to the portion is determined at S512. The system extracts the layer from the file at S514. The system generates an image of the extracted layer at S514. The system projects the image onto the surface of the powder box at S516. The method ends at S518.

Simultaneous and/or parallel to this operation, the system can generate a cue for assigning in the mold removal. FIG. 6 is a flow chart illustrating a method 600 for providing a cue to provide with the projection-assisted mold removal. The method starts at S602. The system can optionally receive sensor information regarding a profile of the powder across the surface of the chamber at S618. The sensor information can be combined across a number of regions. In an embodiment where the fragility of the prototype is taken into account, the system determines whether the fragility information is embedded in the CLI file at S620. This determination is optional for prototypes that do not contain intricate or delicate parts. In response to the CLI file indicating that the prototype does not contain a fragile part in proximity to the region where powder is to be removed (NO at S620), the system generates a cue emphasizing clearance to move powder freely at S622. In response to the CLI file indicating that the prototype contains a fragile part in proximity to the region where powder is to be removed (YES at S620), the system determines the distance between the prototype part and the surface at S626. Generally, the file contains embedded information corresponding to predetermined distances each corresponding to a level of recommended care to be taken when moving powder away from the prototype. In response to the measured distance being greater than a first distance threshold (YES at S624), the system generates a cue emphasizing clearance to move powder freely at S622. In response to the measured distance being equal to or shorter than a first distance threshold (NO at S624), the system compares the distance between the prototype part and the surface to a second distance threshold at S626. The second threshold is less than the first threshold. In response to the measured distance being greater than the second distance threshold (YES at S626), the system generates a cautionary cue at S628 for emphasizing that some caution should be taken during the powder removal. In response to the measured distance being less than or equal to the second distance threshold (NO at S626), the system generates an extreme caution cue at S630 for emphasizing that extreme caution should be taken during the powder removal to avoid a risk of damaging the prototype or part. The system outputs the cue at S632. As discussed supra, the system generates an audible or a color coded cue, or any other cue that is understood in the art to correspond with different levels of caution. In the contemplated embodiment, the cue is output at the same time that the image is projected onto the surface of the powder box. For illustrative purposes, the system can generate the image of the extracted slice including the color coded information corresponding to the cue at S514, before projecting the color coded projection onto the surface of the powder box at S516. The operation returns to S508 and S518 after receipt of each new detection or sensor information until the prototype is fully excavated. The method ends at S634.

The present disclosure also contemplates a projector that can be incorporated as part of a 3D printer. The present disclosure also contemplates a projector that can be in communication with a robotic arms, and particularly the controller of robotic equipment that automates the vacuuming and powder removal from the box.

In yet another embodiment, the projector can be in communication with a mobile image recognition application, such as Google Lens, which displays at least a slice, or a 3D virtual portion, or a 3D version of the prototype as the operator is working on the excavation.

One aspect of the present projection-assisted method is a reduced risk of damage to the prototype that is buried in the powder. The presently disclosed system prepares the operator for the size of the mold to anticipate the mass and to avoid damaging fragile features.

The present disclosure also provides for a faster excavation process that reduces the cost of labor and improves profits, by making the powder box available sooner for other print jobs.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A projector for assisting in a removal of 3D printed molds from a print chamber, the projector comprising a memory storing instructions and a processor programmed to execute the instructions, the process operative to:
receive a file in a format compatible for a 3D printer, the file including instructions for printing a model of an associated prototype as a series of layers;
receive input corresponding to a location of the associated prototype contained in an associated powder box;
using the location, determine a portion of the associated prototype located immediately beneath a top surface of powder in the associated powder box;
determine a layer of the model corresponding to the portion;
extract the layer from the file;
generate an image of the extracted layer; and
project the image onto the top surface of the associated powder box.

2. A system for removing 3D printed molds from a print chamber, comprising:
a projector including a memory storing instructions and a processor programmed to execute the instructions, the process operative to:
receive a file in a format compatible for a 3D printer, the file including instructions for printing a model of an associated prototype as a series of layers;
receive input corresponding to a location of the associated prototype contained in an associated powder box;
using the location, determine a portion of the associated prototype located immediately beneath a top surface of powder in the associated powder box;
determine a layer of the model corresponding to the portion;
extract the layer from the file;
generate an image of the extracted layer; and
project the image onto the top surface of the associated powder box.

3. The system of claim 2 further comprising a database in communication with the projector, the database storing the series of layers, wherein each corresponds to a cross-section or slice of the associated prototype.

4. The system of claim 2 further comprising a sensor in communication with the processor, the sensor measuring the depth of a platform contained in the associated powder box.

5. The system of claim 4, wherein the processor is further operative to:
receive a depth measurement from the sensor; and
read the file to determine the location of the associated prototype.

6. The system of claim 4, wherein the sensor measures a height of a platform in the associated powder box.

7. The system of claim 2 further comprising a graphic user interface including:
an input unit allowing an operator to move through and select from images corresponding to the series of layers; and,
a display for displaying the images.

8. The system of claim 2, wherein the projector projects the image as a visual rendering of a current layer onto the top surface of the associated powder box.

9. A system of claim 2, wherein the processor is further operative to:
using the location, determine a distance of the portion of the associated prototype located immediately beneath a surface of powder to a selected region of the surface;
generate a cue based on the distance;
output or project the cue in or within a proximity of the portion.

10. The system of claim 9, wherein the cue is a color coded region indicative of a level of caution recommended for a removal of powder within the region.

11. A method for removing 3D printed molds from a print chamber, comprising:
receiving at a processor a file in a format compatible for a 3D printer, the file including instructions for printing a model of an associated prototype as a series of layers;
receiving input corresponding to a location of the associated prototype contained in an associated powder box;
using the location, determining a portion of the associated prototype located immediately beneath a top surface of powder in the associated powder box;
determining a layer of the model corresponding to the portion;
extracting the layer from the file;
generating an image of the extracted layer; and
projecting the image onto the top surface of the associated powder box.

12. The method of claim 11 further comprising:
storing the series of layers in a database in communication with the processor, wherein layers each corresponds to a cross-section or slice of the associated prototype.

13. The method of claim 12 further comprising:
receiving a depth measurement from a sensor in communication with the processor, the depth corresponding to a height of a platform contained in the associated powder box.

14. The method of claim 13, wherein the processor is further operative to:
read the file to determine the location of the associated prototype.

15. The method of claim 13 further comprising:
receiving input from a graphic user interface in connection with the processor;
displaying an image on a display of the interface in response to the input.

16. The method of claim 11, further comprising:
projecting the image as a visual rendering of a current layer onto the top surface of the associated powder box.

17. The method of claim 11, wherein the processor is incorporated in a projector.

18. The method of claim 11, wherein the processor is incorporated in a server computer and the projecting is performed by a projector in communication with the server computer.

19. A computer program product comprising a non-transitory recording medium storing instructions which, when executed on a computer, cause the computer to perform the method of claim 11.
